(19) United States
(12) Patent Application Publication
(10) Pub. No.: US 2010/0018458 A1
(43) Pub. Date: Jan. 28, 2010

(54) CURTAIN COATING DEVICE WITH POROUS CURTAIN GUIDE STRUCTURE, CURTAIN GUIDE STRUCTURE FOR A CURTAIN COATING DEVICE, AND METHOD FOR PRODUCING THE CURTAIN GUIDE STRUCTURE

(75) Inventors: Peter Schweizer, Wuennewil (CH); Ferdinand Krebs, Wabern (CH)

Correspondence Address: RATNERPRESTIA, P.O. BOX 980, VALLEY FORGE, PA, 19482, US

(73) Assignee: Polytype Converting S.A., Fribourg (CH)

(21) Appl. No.: 12/305,084

(22) PCT Filed: Jun. 29, 2007
(86) PCT No.: PCT/EP07/05790

§ 371 Date: May 28, 2009

(30) Foreign Application Priority Data
Jun. 30, 2006 (DE) 10 2006 030 183.8

(51) Int. Cl. B05C 5/00; B23P 13/00

(52) U.S. Cl. 118/300; 29/557

(57) ABSTRACT

A curtain coater for coating a substrate, comprising: a nozzle system for creating a curtain of at least one coating fluid dropping onto the substrate, a porous curtain guide structure, which has a guide surface for providing a lateral guiding action for the curtain, which cambers round convexly towards the curtain across a width extending beyond the thickness of the curtain measured transversely to the curtain, at least one cavity extending in the longitudinal direction of the curtain guide structure for an auxiliary fluid to be guided on the guide surface and a cavity wall surrounding the cavity, of which the curtain guide structure forms only a circumferential segment, and the circumferential segment bounding the cavity is a part of an external contour of the curtain guide structure extending about a longitudinal axis of the curtain structure.

This application is the U.S. national phase application of PCT International Application No. PCT/EP2007/005790 which claims priority to German Utility Registration. No. 10 2006 030 183.8 filed Jun. 30, 2006, both of which are incorporated in their entirety by reference herein.

### BACKGROUND OF THE INVENTION

1. Technical Field

The invention relates to a curtain coater for coating a substrate, which has a porous and hence liquid-permeable curtain guide structure at least on one side edge of the curtain to provide a lateral guide for a single- or multi-layered curtain. The invention further relates to a method of producing a curtain guide structure and a curtain guide structure as such.

2. Description of the Related Art

A curtain coater of the type outlined above is known from patent specification DE 10 2004 016 923 A1. The porous curtain guide structure is hollow cylindrical. During operation of the curtain coater, the cavity of the curtain guide structure is filled with an auxiliary fluid which passes from the inside to the outside due to the porosity of the curtain guide structure and emerges on an external guide surface. The curtain is guided on the guide surface, and the auxiliary fluid emerging there forms a boundary layer between the guide surface and the curtain fluid. The known curtain guide structure is a tube with an external diameter that is identical all over and an internal diameter which becomes continuously smaller from a top end of the curtain guide structure to the bottom end so that the cavity is conical. Due to the resultant variation in the wall thickness, the disruption to the boundary layer across the drop height of the curtain can be set so that the auxiliary fluid is at the same flow speed as the free-falling curtain fluid in the outer boundary layer region where the auxiliary fluid makes contact with the coating fluid. This prevents disruptive effects, in particular braking effects, caused by the lateral guide on the coating fluid. However, the porous curtain guide structure is difficult and expensive to produce. There are also problems with the precision.

### SUMMARY OF THE INVENTION

An objective of the invention is to simplify the process of manufacturing a porous curtain guide structure and reduce the price without compromising the precision of the geometry, and preferably improving precision.

A curtain coater of the type to which at least one aspect of the invention relates comprises a nozzle system for generating a curtain of at least one coating fluid dropping on a substrate and a guide system with a porous curtain guide structure, which has a guide surface to provide a lateral guiding action for the curtain. The guide surface is wider than the curtain is thick, i.e. the width of the guide surface measured parallel with the thickness of the curtain is greater than the thickness of the curtain. The guide surface cambers round convexly with respect to the curtain across this width, i.e. it cambers in an arrangement arching towards the curtain. A cavity for accommodating an auxiliary fluid extends along the curtain guide structure. In particular, the cavity may extend across the entire length of the curtain guide structure, although it would in principle be conceivable for the cavity to extend across only a longer part, preferably the major part of the length of the curtain guide structure. A longitudinal axis of the curtain guide structure is at least essentially parallel with the dropping direction of the curtain when the curtain is not being disrupted by external influences.

As proposed by the invention, the curtain guide structure constitutes only a circumferential segment of a cavity wall surrounding the cavity and does not extend around the entire cavity wall, as is the case with the curtain guide structure disclosed in DE 10 2004 016 923 A1. In particular, the circumferential segment formed by the curtain guide structure, which constitutes a part of the side wall of the cavity, is part of an external contour of the curtain guide structure extending about the longitudinal axis, i.e. part of an external surface of the curtain guide structure. The external surfaces forming the external contour are preferably smooth surfaces apart from the roughness caused by the porosity. The surface normals of these surfaces along the external contour point away from one another, preferably everywhere, or are parallel with one another by one of the surfaces respectively. The circumferential segment preferably sits transversely to, preferably perpendicular to, the longitudinal direction in one or more cross-sections for example. However, although less preferable, a situation should not be ruled out in which channels or recesses of some other type are provided in the surfaces.

This being the case, the curtain guide structure no longer has the shape of a tube, the internal diameter of which has to undergo complex boring to produce the preferred variation in wall thickness. In order to vary the wall thickness towards the guide surface as preferred, only one surface or optionally also several surfaces of the curtain guide structure freely accessible from outside needs or need to be processed or produced in a simple cutting process. Furthermore, several circumferential segments, at least two circumferential segments, are obtained from a single solid cylindrical or hollow cylindrical initial body by means of a cutting process, each of which may form a curtain guide structure. Not only does this simplify processing, it also means that material can be saved. The fact of having to machine surfaces or work on surfaces that are freely accessible from outside also contributes towards the precision. Finally, the wall thickness can be reduced compared with a tube made from a porous material which has to be bored or drilled out.

A rear face facing away from the guide surface, hereafter referred to as outer rear face, is preferably straight in terms of its cross-section. It is preferably straight in every cross-section and more particularly preferably planar, i.e. is also straight in the longitudinal direction of the curtain guide structure so that the guide structure tapers in a conical shape from one end to the other in a longitudinal section and the wall thickness linear measured in the longitudinal section decreases. Optionally, however, the wall thickness may also decrease progressively or degressively in the longitudinal direction. In such embodiments, the outer rear face cambers in a convexly or concavely round arrangement. In principle, it would also be conceivable for the wall thickness or thickness of the curtain guide structure to vary in discrete steps, i.e. in stages. Since, for the purpose of the invention, the rear face is a free surface which is freely accessible from the outside, especially for processing, rather than a circumferentially extending internal face of a tube, the rear face can be processed unobstructed, in particular in any manner involving the removal of material, especially milling, and is able to undergo fine finishing work, for example polishing. The thickness of the curtain guide structure can therefore be freely and precisely adjusted without any restrictions imposed by the production method, with a view to adapting the flow speed of the auxiliary fluid to the speed at which the curtain falls.

In examples of preferred embodiments, the curtain guide structure has an external contour about its longitudinal axis comprising the guide surface cambering forwards in a rounded arrangement and other external faces respectively facing away from one another. The other external faces are preferably planar in each case, although this is not absolutely necessary. In preferred embodiments, the curtain guide structure is therefore a sectionalised flat surface, apart from the guide surface, which has a finite radius of curvature. In the mathematical sense, the curtain guide structure resembles a prism. However, the curtain guide structure differs from a prism due to the curved guide surface and, in the preferred embodiments with a varying wall thickness, due to the preferably non-congruent end faces. Viewed as a whole, however, it is at least essentially prismatic. The external faces of the curtain guide structure are parallel with one another with the exception of the rear face in a preferred embodiment.

The curtain guide structure has fine capillaries extending uniformly through it, i.e. it is openly porous. It preferably has the same degree of porosity all over. In terms of material, it may be a ceramic material in particular. The porosity is advantageously so fine that auxiliary fluid delivered to a surface facing away from the guide surface, preferably the outer rear face, penetrates the curtain guide structure and leaves the guide surface uniformly across its entirety. In addition to its porosity, the curtain guide structure may have macroscopic cavities, for example a bore, although it preferably has no cavities in addition to its capillary pores and in this sense is a solid body.

The guide surface cambers out from an imaginary chord surface in the direction towards the curtain. The chord surface is an internal surface of the curtain guide structure which is straight in every cross-section and extends from a side edge of the guide surface as far as the other side edge. The chord surface is preferably planar. The thickness or wall thickness of the curtain guide structure measured in the lateral extension of the curtain comprises the camber thickness measured as the distance between the guide surface and the chord surface and the remaining thickness measured as a distance between the chord surface and the rear face. In preferred embodiments, the remaining thickness is thicker than the camber thickness. If the total thickness or wall thickness varies across the length of the curtain guide structure as preferred, the thinnest remaining thickness is preferably thicker than the camber thickness or, if this varies, than the thickest camber thickness. However, the camber thickness is constant in each longitudinal section across the length of the curtain guide structure and varies only in terms of cross-section. The remaining thickness is preferably at least 1.5 times, more preferably at least twice the thickness of the thickest camber thickness all over or at least in the region through which the auxiliary fluid flows in preferred embodiments. As a result, the auxiliary fluid flowing through the porous material in the direction towards the guide surface is uniformly distributed and thus uniformly distributed across the entire guide surface as it leaves it, and a uniform flow volume is produced on every vertical line across the width of the guide surface. In order to compensate for the variation in flow resistance through the curtain guide structure which occurs due to the camber, it is also possible, as an alternative or in addition to such an arrangement, to select the proportion of the rear face or side face which sits in contact with the auxiliary fluid. In one variant, the rear face to which the auxiliary fluid is preferably directed is not straight but is of a shape congruent with the guide surface so that the guide surface and rear face extend parallel with one another in cross-section. In the longitudinal direction, however, the rear face is also preferably inclined towards the guide surface in such embodiments.

The guide surface is preferably shaped as described in patent specification DE 10 2004 016 923 A1, which is included herein by way of reference. Across its width, therefore, it describes an arc, which has an overall radius of curvature of preferably at least 5 mm across the width. The radius of curvature along the arc overall is at least 4 mm. The radius of curvature is preferably constant along the arc. In preferred embodiments, the radius of curvature has the same sign overall along the arc. In order to produce the effect described in DE 10 2004 016 923 A1, the width of the guide surface should be at least 1.5 times, preferably at least double the thickness of the curtain. Instead of the preferred arc, however, the guide surface may also describe an elliptical arc or an arc of a different oval shape in principle. However, an arc is preferred both in terms of the manufacturing process and hence costs and with a view to achieving the desired effect, namely guiding the curtain to the straight, ideal drop line.

The invention further relates to a method of producing a curtain guide structure for a curtain coater, in particular producing the curtain guide structure described above in its various embodiments. The curtain guide structure is made from a cylinder of porous material which is permeable to fluids, namely the auxiliary fluid used in the respective application. As proposed by the invention, at least one polyhedron with a cylindrical surface and at least two planar external side faces is formed from this semi-finished product by means of a cutting process, preferably sawing or cutting. Preferably, at least two or more such polyhedrons are produced from the cylindrical semi-finished product by cutting. In particular, the semi-finished product might be a solid cylinder or a hollow cylinder with a single straight bore. The cylindrical surface of the polyhedron may be used directly for the guide surface. If necessary, the cylindrical surface may be subjected to a fine finishing process, for example ground or polished. The cylinder is preferably a circular cylinder.

If the thickness of the curtain guide structure in the longitudinal direction is to vary, preferably the outer rear face of the polyhedron remote from the cylindrical surface is processed to remove material after cutting, preferably by machining, for example milling. As an alternative to such a machining process following the cutting step, the thickness variation may also be produced directly during the cutting operation, in which case the cylindrical semi-finished product is cut evenly in the longitudinal direction to the desired thickness variation, for example by an oblique saw cut.

In preferred embodiments, the curtain guide structure has side faces on the two sides of the guide surface, which are straight in cross-sections of the curtain guide structure, preferably in every cross-section of the curtain guide structure. The side faces should also be at least essentially parallel in cross-sections. In the longitudinal direction of the curtain guide structure, the side faces may have an inclination, in particular a constant inclination. Preferred embodiments are those in which the side faces are respectively planar everywhere.

The invention further relates to a curtain guide structure as such, which has not yet been mounted in a curtain coater but may be provided for use in a curtain coater of the described type. The invention further relates to a joined unit comprising the curtain guide structure and a bearing structure, in or on which the curtain guide structure is mounted. The curtain guide structure as such as well as its joined unit incorporating the bearing structure advantageously has or have one or more of the features described above for the relevant component of the curtain coater.

The invention also relates to a method of producing a curtain guide structure. In accordance with the method, the curtain guide structure is formed as a polyhedron, which has an external contour extending about a longitudinal axis, comprising a cylindrical surface, i.e. a circumferential segment of a cylindrical surface, and at least two surfaces which are straight, preferably totally planar surfaces in cross-sections of the curtain guide structure. The axial ends of the curtain guide structure are preferably also respectively planar. In preferred embodiments, the curtain guide structure is formed from a cylindrical semi-finished product by a cutting process, either from a full cylindrical or a semi-cylindrical semi-finished product. Appropriate cutting processes are sawing and cutting. If the curtain guide structure is intended to have a thickness which varies in the longitudinal direction as preferred, it is subjected to additional processing to remove material after cutting. It is preferable to use a machining process, in particular milling or polishing. If necessary, one or more of the surfaces is then subjected to a fine finishing process, i.e. fine polishing, polishing or similar. Alternatively, however, it would also be conceivable in principle for the curtain structure to be made directly in an original shaping process, for example by sintering, to obtain the desired porosity and forming to obtain said surfaces. Compared with such methods, however, the preferred method of using a cylindrical semi-finished product has a considerable price advantage because the semi-finished product can be purchased relatively cheaply in a standard length, cut into pieces of the length needed for the curtain guide structure and the resultant pieces cut to length can be cut immediately into several circumferential segments or sectors immediately, enabling several curtain guide structures to be obtained from each piece cut to length.

### BRIEF DESCRIPTION OF THE DRAWINGS

An example of an embodiment of the invention will be described below with reference to the appended drawings. Features disclosed in this description of an embodiment may be used individually and in any combination of features as well as the embodiments described above. Of the drawings:

FIG. 1 illustrates a curtain coater with a nozzle system in the form of a slotted nozzle,

FIG. 2 illustrates a curtain coater with a nozzle system based on a cascaded nozzle,

FIG. 3 shows the curtain coater illustrated in FIG. 2 with a guide system, which has a porous curtain guide structure for laterally guiding a curtain fluid,

FIG. 4 illustrates the guide system,

FIG. 5 shows a cross-section of the curtain guide structure,

FIG. 6 is a cross-section of the guide system with the curtain guide structure,

FIG. 7 shows the guide system with the curtain guide structure viewed in a longitudinal section,

FIG. 8 illustrates a cylindrical semi-finished product for producing the curtain guide structure,

FIG. 9 illustrates a cylindrical segment obtained from the semi-finished product by a cutting process and

FIG. 10 illustrates the finishing work performed on the curtain guide structure obtained from the cylindrical segment viewed in a longitudinal section

### DETAILED DESCRIPTION OF THE PREFERRED EMBODIMENTS

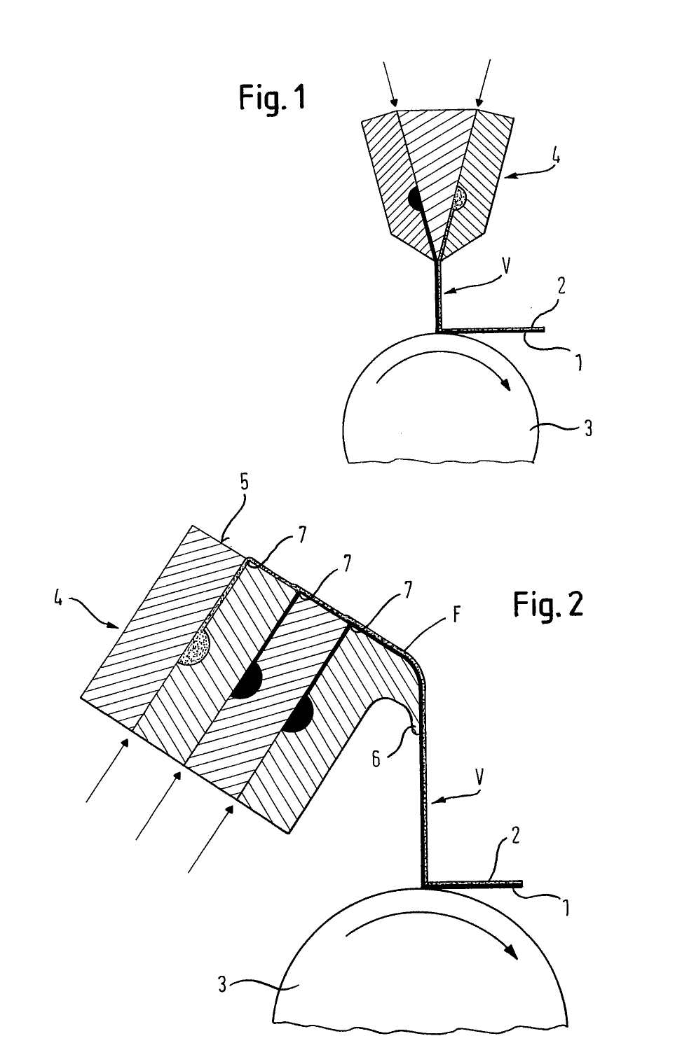

FIG. 1 illustrates a curtain coater with a nozzle system 4 disposed vertically above a roller 3 by a clearance distance. The roller 3 serves as a pulley system or more generally as a support system for a substrate to be coated 1, which is conveyed in a loop around the roller 3. The substrate 1 is an endlessly conveyed flexible web. The nozzle system 4 is a slotted nozzle incorporating separate inlets for several different coating fluids. The inlets converge at a bottom end of the nozzle system 4 facing the substrate 1 in a nozzle outlet orifice. The coating fluids leave the outlet orifice of the nozzle system 4 free-falling in the form of a multi-layered fluid curtain V.

FIG. 2 illustrates a curtain coater with a nozzle system 4 in the form of a cascaded nozzle. It has a nozzle surface which is inclined relative to the horizontal so that a coating fluid delivered to the nozzle surface 5 moves downwards on the nozzle surface 5 to a nozzle lip 6 and flows across the nozzle lip 6 out into the free-falling curtain V. Several coating fluids are delivered to the nozzle surface 5 via outlet orifices, which form a multi-layered film flow F on the nozzle surface, which flows over the nozzle lip 6 into the curtain V. The substrate 1 and roller 3 correspond to the embodiment illustrated as an example in FIG. 1.

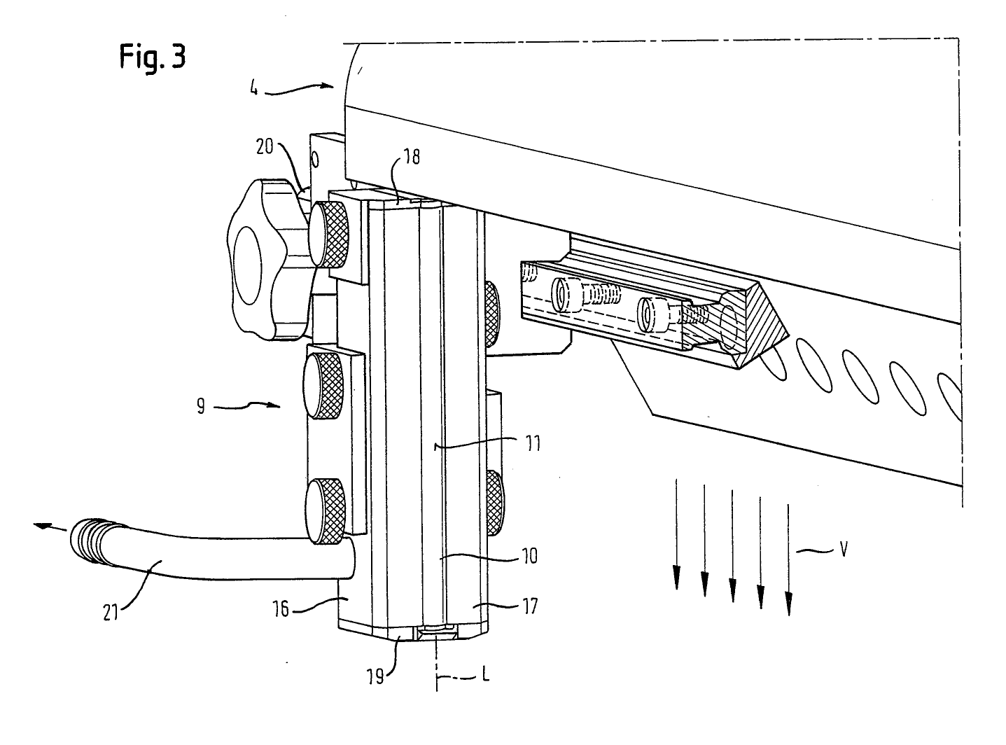

FIG. 3 is a perspective diagram illustrating a lateral edge region of the curtain coater illustrated in FIG. 2. Only the part of the curtain coater disposed above the roller 3 is illustrated. Disposed between the nozzle system 4 and the roller 3, not illustrated, is a guide system 9. The guide system 9 comprises a curtain guide structure 10 which guides the curtain V. The curtain guide structure 10 extends lengthways in the drop direction of the curtain V and has a longitudinal axis L disposed parallel with the desired ideal drop direction. The curtain guide structure 10 is retained in a multi-part bearing structure of the guide system 9. The bearing structure holds the curtain guide structure 10 in an exact position with the exception of a free guide surface 11 facing the curtain V. The bearing structure comprises two side parts 16 and 17 extending in the longitudinal direction of the curtain guide structure 10 which hold the curtain guide structure 10 lengthways between them and a top cover 18 and a bottom cover 19 directed towards the two end faces of the curtain guide structure 10. The guide system 9 also has an inlet 20 and an outlet 21 for an auxiliary fluid.

The curtain guide structure 10 has an open porosity across its entire length. Micro-capillaries extend through the porous material, resulting in a uniform porosity. The curtain guide structure 10 sits in contact with a reservoir of the auxiliary fluid across its entire length at an external face directed away from the guide surface 11. The auxiliary fluid is delivered to the reservoir via the inlet 20. The auxiliary fluid penetrates the curtain guide structure 10 and leaves it at its guide surface 11, forming a flow constituting a boundary layer of auxiliary fluid flowing across the entire surface of the guide surface 11 and down in the drop direction of the curtain V. The boundary layer flow is in contact with the or several coating fluids of the curtain V, but separates the curtain V from the guide surface 11. The auxiliary fluid of the boundary layer therefore acts as a sort of lubricating film between the curtain V and the curtain guide structure 10. Since the curtain V is laterally guided, the frictional forces acting on it can be reduced. The boundary layer flow is preferably generated in such a way that the auxiliary fluid in the contact region with the curtain V along the curtain guide structure 10 is at the same flow speed everywhere in the drop direction of the curtain V as the free curtain flow not affected by the lateral guide. This corresponds to at least the desired optimum state.

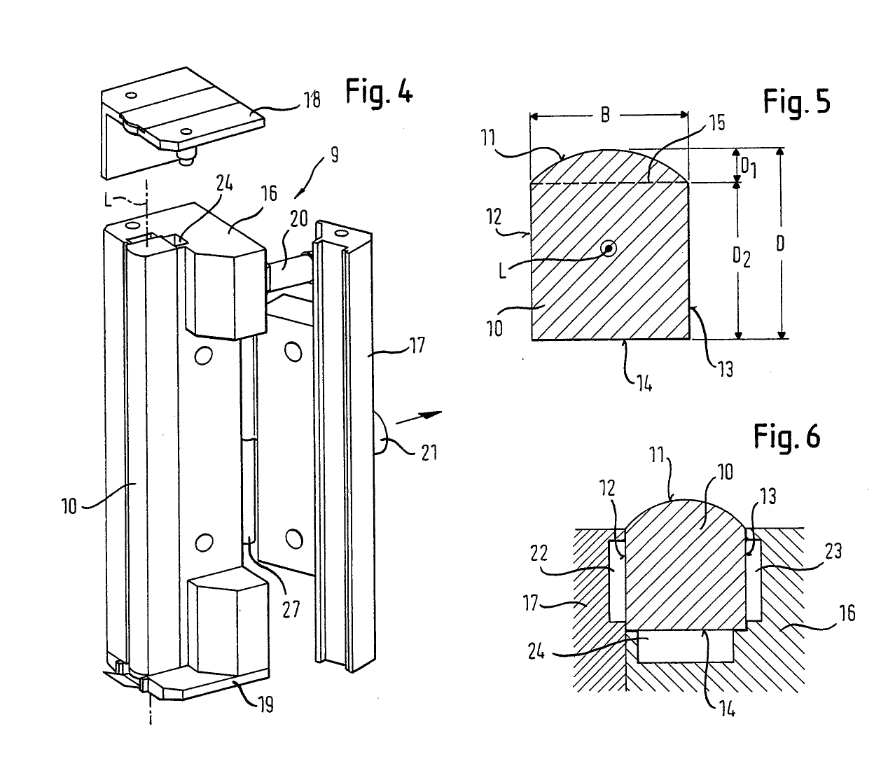

FIG. 4 illustrates the guide system 9 released from the curtain coater. The two side parts 16 and 17 of the bearing structure are connected to one another in a pivot joint 27 so that they can be folded. FIG. 4 illustrates the guide system 9 with the side parts 16 and 17 folded open and the cover 18 not yet mounted. The curtain guide structure 10 is positioned in the side part 16 in an exact fit by placing the curtain guide structure 10 in contact with slim contact surfaces of the side parts 16 across its entire length. The side part 17 can be folded in the pivot joint 27 about a pivot or folding axis parallel with the longitudinal axis L towards the curtain guide structure 10 and, in the state when folded and closed, sits in contact with the curtain guide structure 10, likewise across its entire length, at slim contract surfaces. In the fitted state, the side parts 16 and 17 are clamped to one another by a certain tensile force so that they hold the curtain guide structure 10 clamped between them. The covers 18 and 19 are positioned relative to the side parts 16 and 17 by means of positioning pins and secured on them. In the fitted state, they seal off the curtain guide structure 10 at its top and bottom end.

Consequently, the bearing structure 16-19 and the curtain guide structure 10 constitute a joined unit based on nothing more than a positive and non-positive connection.

FIG. 5 illustrates the curtain guide structure 10 in cross-section, released from the guide system 9, and FIG. 6 illustrates the curtain guide structure 10 and the region of the side parts 16 and 17 directly adjoining the curtain guide structure 10 and holding the curtain guide structure 10, likewise in cross-section.

The shape of the curtain guide structure 10 overall is essentially that of a prism, the external contour of which extending about the longitudinal axis (L) is made up of four surfaces pointing towards one another at an angle, which abut with one another at longitudinal edges, namely the guide surface 11, two planar side faces 12 and 13 and a planar rear face 14, which forms a circumferential segment of a cavity 24 for example. The side faces 12 and 13 are disposed parallel with the longitudinal axis L and at a right angle with respect to the rear face 14. The guide surface 11 is circular cylindrical and in the fitted state arches towards the curtain V, i.e. it arches convexly towards the curtain V. The guide surface 11 is likewise parallel with the longitudinal axis L of the curtain guide structure 10. Its chord surface 15, shown by a broken line in FIG. 5, is planar and forms a rectangle with the side faces 12 and 13 and the rear face 14 in every cross-section. The width of the chord surface 15 corresponds to the width B of the curtain guide structure 10 measured parallel with the thickness of the curtain V.

The thickness D of the curtain guide structure 10 is measured in the extension of the curtain plane and represents the biggest distance in each case between the guide surface 11 and the rear face 14 of each cross-section. The thickness D in the respective cross-section is the sum of a camber thickness D₁ and a remaining thickness D₂. The camber thickness D₁ in the respective cross-section is the biggest distance between the guide surface 11 and the chord surface 15. The remaining thickness D₂ is the distance between the chord surface 15 and the rear face 14 in the respective cross-section.

The side part 16 lies with two narrow longitudinal strips against the rear face 14 along the entire length of the curtain guide structure 10. A recess is disposed in the side part 16 between the two longitudinal strips, which likewise extends across the entire length of the curtain guide structure 10, and in the embodiment illustrated as an example is a rectangular groove. As a result of the recess, a cavity 24 is formed at the rear face 14, the side walls of which form the rear face 14 and also the side part 16. Cavities 22 and 23 adjoining the side faces 12 and 13 are obtained in the same way, the side walls of which form the side face 13 in one instance and also the side part 16 and, in the case of the cavity 22, the side face 12 and also the side part 16.

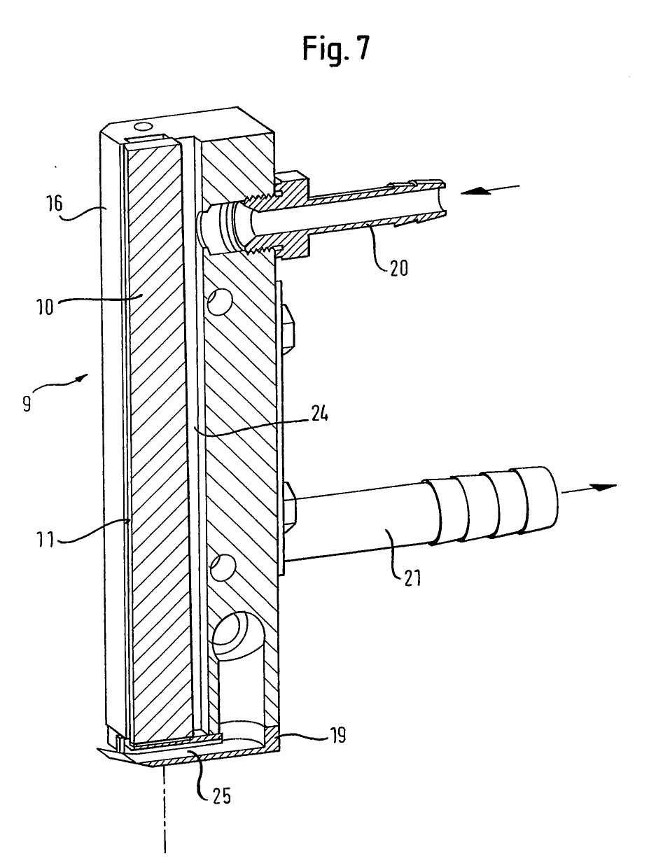

FIG. 7 is a perspective view illustrating the guide system 9 with the curtain guide structure 10 looking onto a longitudinal section plane through the curtain guide structure 10 and the adjoining cavity 24 at the rear. The inlet 20 opens into the cavity 24. The outlet 21 opens at the bottom end of the guide surface 11, namely via a discharge passage 25, although for the sake of simplicity this is counted as belonging to the outlet 21. The cavity 24 and also the cavities 22 and 23 are separated from the outlet 21 in terms of the fluid flow, i.e., they are not directly connected to the discharge passage 25. The separation is achieved by means of the curtain guide structure 10 and the bottom cover 19. The cover 19 seals off the cavities 22, 23 and 24 at the bottom. The top cover 18, which lies tightly against the top end of the curtain guide structure 10 in the fitted state and also seals off the top of the cavities 22 to 24, is not illustrated in FIG. 7.

As illustrated in FIG. 7, the thickness D of the curtain guide structure 10 varies in the longitudinal direction. The variation in thickness is such that the thickness D of the curtain guide structure 10 (FIG. 5) becomes monotonically bigger, preferably continually, from the top end to the bottom end of the curtain guide structure 10, and does so linearly in the embodiment illustrated as an example. Accordingly, the rear face 14 has a constant inclination with respect to the longitudinal axis L across the entire length of the cavity 24. The thickness of the cavity 24 decreases in conformity with this inclination from the top end to the bottom end. The other two cavities 22 and 23, on the other hand, do not vary across their length. The variation in the thickness of the curtain guide structure 10 is selected so that the boundary layer formed from the auxiliary fluid on the guide surface 11 in the longitudinal direction sets the drop speed of the free curtain flow in the outer peripheral region during operation. In this sense, the flow resistance of the curtain guide structure 10 by reference to the longitudinal direction is influenced by the thickness variation and hence the flow volume of the auxiliary fluid emerging on the guide surface 11 per unit of surface area.

A uniform flow volume in the width direction is obtained firstly due to the fact that the remaining thickness D₂ is thicker than the biggest camber thickness D₁ (FIG. 5) and secondly due to the fact that cavities 22 and 23 are provided in the side faces 12 and 13, in which the auxiliary fluid always collects after a brief run-in phase. As a result of the bigger remaining thickness, the effect of differing flow lengths which occurs in the respective cross-section of the curtain guide structure 10 due to the camber of the guide surface 11 is reduced. Due to the lateral cavities 22 and 23, short flow paths are created from the side faces 12 and 13 to the guide surface 11. However, due to the throttling effect of the curtain guide structure 10, the fluid pressure in the cavities 22 and 23 is lower than in the cavity 24.

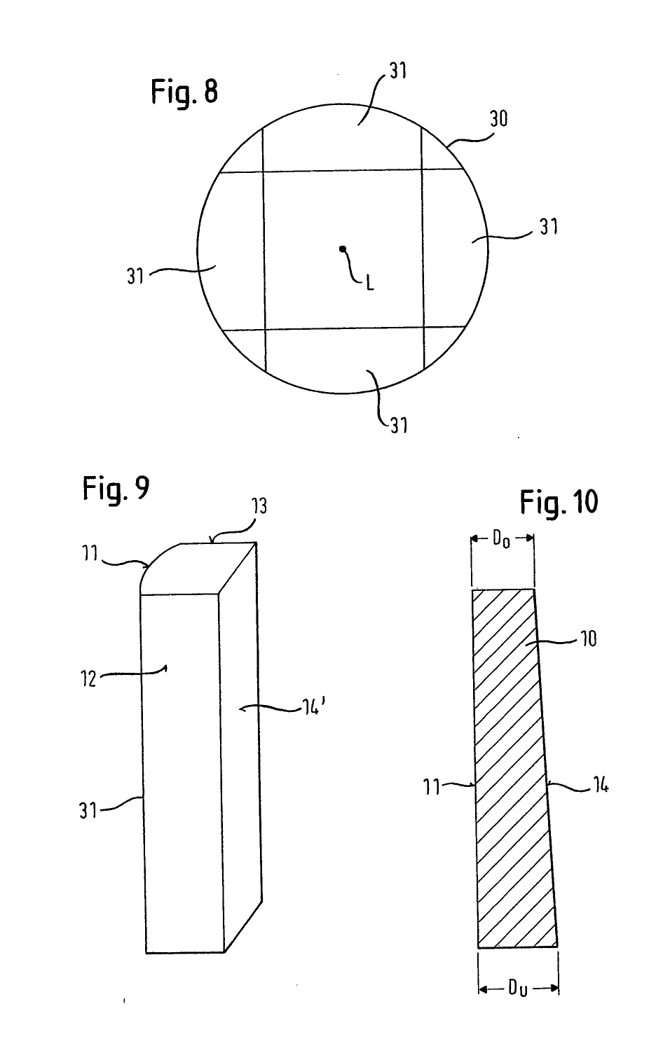

FIG. 8 is a plan view onto a planar end face illustrating a circular cylinder 30 made from a porous material with open porosity. In the embodiment illustrated as an example, it is a solid cylinder, i.e. the cylinder 31 has a uniform density across its entire cross-section in terms of its porosity and, apart from its capillary pores, does not have any internal macroscopic cavities. The cylinder 31 is supplied as a semi-finished product, cut to length, preferably to the length of the curtain guide structure 10, and then split into several identical cylinder segments 31 by an appropriate cutting process. In the embodiment illustrated as an example, it is split into four identical cylinder segments 31. The straight cutting lines are indicated in the plan view.

FIG. 9 illustrates one of the four identical cylinder segments 31 obtained after the cutting step. The cylinder segment 31 has a circular cylindrical external face, which can be used as the guide surface 11 of the curtain guide structure 10 to be produced immediately or optionally following fine machining. As a result of cutting, three planar external faces 12, 13 and 14′ are obtained parallel with the longitudinal axis L of the cylinder 31, which in conjunction with the cylindrical surface or guide surface 11 form the external contour of the cylinder segment 31. The external faces 12 and 13 may be used directly for the side faces of the curtain guide structure 10 are may optionally be subjected to a fine machining process. However, the rear face 14′ is subjected to a cutting or polishing process to remove material.

In order to obtain the thickness variation illustrated again in FIG. 10, the cylinder segment 31 illustrated in FIG. 9 may be milled at its rear face 14′ until the described thickness variation of the curtain guide structure 10 is obtained, with a slimmest thickness Dₒ at the top end and a biggest thickness Dᵤ at the bottom end of the curtain guide structure 10. The rear face may then also be subjected to a fine machining process if necessary.

In the embodiment illustrated as an example in FIGS. 8 to 10, the semi-finished product, namely the cylinder 30, is split into four identical cylinder segments 31. Another option is to split it into only two oppositely lying cylinder segments 31 and in principle it would also be conceivable to split off only a single cylinder segment 31.

In yet another variation, the semi-finished product is not a solid cylinder 30 but a hollow cylinder. The internal face of the hollow cylinder forms a round rear face of the cylinder circumferential segment obtained by the described cutting process. The round rear face may be straightened in a subsequent method step or also machined in a process to remove material to form a round rear face to towards what will subsequently be the bottom face of the curtain guide structure. A round rear face may even be of advantage, especially if it extends congruently with, i.e. parallel with, the guide surface 11 because in this case, the flow path inside the curtain guide structure 10 is of the same length everywhere across the width of the curtain guide structure 10. For reasons of cost, however, a planar rear face 14 is preferred.

1. Curtain coater for coating a substrate, comprising:
a) a nozzle system for creating a curtain of at least one coating fluid dropping onto the substrate,
b) a porous curtain guide structure, which has a guide surface for providing a lateral guiding action for the curtain, which cambers round convexly towards the curtain across a width extending beyond the thickness of the curtain measured transversely to the curtain,
c) at least one cavity extending in the longitudinal direction of the curtain guide structure for an auxiliary fluid to be guided on the guide surface
d) and a cavity wall surrounding the cavity, of which the curtain guide structure forms only a circumferential segment,
e) and the circumferential segment bounding the cavity is a part of an external contour of the curtain guide structure extending about a longitudinal axis of the curtain structure.

2. Curtain coater as claimed in claim 1, wherein the curtain guide structure has outer side faces on both sides of the guide surface which are straight in cross-sections of the curtain guide structure.

3. Curtain coater as claimed in claim 2, wherein the side faces are planar in each case.

4. Curtain coater as claimed in claim 1, wherein the curtain guide structure has an outer rear face fat the rear facing away from the guide surface which is straight in cross-sections of the curtain guide structure.

5. Curtain coater as claimed in claim 2, wherein the curtain guide structure has an outer rear face at the rear facing away from the guide surface which is straight in cross-sections of the curtain guide structure and the rear face extends as far as the side faces.

6. Curtain coater as claimed in claim 4, wherein the rear face of the curtain guide structure forms the circumferential segment of the cavity wall.

7. Curtain coater as claimed in claim 1, wherein the curtain guide structure has a thickness measured transversely to its width which monotonically decreases along a longitudinal axis of the curtain guide structure and can be varied constantly.

8. Curtain coater as claimed in claim 1, wherein the external contour comprises the guide surface and preferably planar external faces pointing at an angle to one another.

9. Curtain guide structure as claimed in claim 8, wherein the guide surface, the planar side faces and a rear face at the rear facing away from the guide surface form the external contour.

10. Curtain coater as claimed in claim 1, in which the curtain guide structure has a thickness in a direction disposed transversely to its width and to its length which is the sum of a camber thickness and a remaining thickness,
and the camber thickness is measured as a distance between the guide surface and a chord surface respectively constituting a chord in cross-sections of the curtain guide structure the guide surface which connects the side edges of the guide surface to one another,
and the remaining thickness is measured as the distance between the chord surface and a rear face of the curtain guide structure at the rear facing away from the guide surface,
and a biggest camber thickness in the respective cross-section is at least as thick as a slimmest remaining thickness of the same cross-section.

11. Curtain coater as claimed in claim 1, wherein the guide surface forms an arc across its width which has an overall radius of curvature of at least 4 mm.

12. Curtain coater as claimed in claim 1, wherein the width of the guide surface is at least 1.5 times the thickness of the curtain.

13. Curtain coater as claimed in claim 1, wherein the guide surface is at least one of a cylinder surface and circle arc segment surface.

14. Curtain coater as claimed in claim 1, further comprising an inlet opening into the cavity and an outlet opening at the guide surface for the auxiliary fluid.

15. Curtain coater as claimed in claim 1, wherein the cavity extends along an outer rear face of the curtain guide structure at the rear facing away from the guide surface.

16. Curtain coater as claimed in claim 1, further comprising a bearing structure which constitutes a joined unit with the curtain guide structure and forms the cavity.

17. Curtain coater as claimed in claim 16, wherein the bearing structure holds the curtain guide structure in an exact fit and surrounds it leaving it free except for the guide surface.

18. Curtain coater as claimed in claim 16, wherein the curtain guide structure and the bearing structure jointly form the walls of the cavity.

19. Curtain coater as claimed in claim 16, wherein the bearing structure comprises a middle portion holding the curtain guide structure at the side and two covers, which respectively hold the curtain guide structure at one end.

20. Curtain coater as claimed in claim 19, wherein the middle portion has side parts and the curtain guide structure is positively positioned between the side parts and the covers, and is held clamped solely by means of tensile forces acting between the side parts and the covers.

21. Curtain coater as claimed in claim 20, wherein the curtain guide structure and only one of the side parts form side walls of the cavity.

22. Curtain coater as claimed in claim 1, wherein at least one other cavity for the auxiliary fluid is provided extending in the longitudinal direction of the curtain guide structure adjoining the curtain guide structure, and the curtain guide structure constitutes only a circumferential segment of a cavity wall surrounding the at least one other cavity.

23. Curtain guide structure for a curtain coater,
a) which is at least predominantly made from a porous material of uniform, open porosity,
b) and has an external contour extending about a longitudinal axis with a concavely cylindrical surface with respect to a straight line intersecting the longitudinal axis at a right angle, wherein
c) the external contour comprises surfaces which are straight in cross-sections of the curtain guide structure.

24. Method of producing a curtain guide structure for a curtain coater, by means of which a curtain of at least one coating fluid can be created, which drops onto a substrate to be coated and can be guided by a guide surface of the curtain guide structure at one side,
and the curtain guide structure has the shape of a polyhedron, the external contour of which comprises at least one cylindrical surface forming the guide surface and at least two planar surfaces.

25. Method as claimed in claim 24, wherein the polyhedron is formed from a cylinder of porous material permeable to an auxiliary fluid by means of a cutting process.

26. Method as claimed in claim 24, wherein a thickness of the polyhedron measured between the cylindrical guide surface and a rear face facing away from the guide surface along a longitudinal axis of the polyhedron is adjusted by removing material so that it decreases from one axial end in the direction towards the other end.

27. Method as claimed in claim 24, wherein the cylinder or the polyhedron is split so that its thickness measured between the cylindrical guide surface and a rear face at the rear facing away from the guide surface along a longitudinal axis of the cylinder or polyhedron decreases from one axial end in the direction towards the other end.

28. Curtain coater as claimed in claim 2, wherein the outer side faces on both sides of the guide surface are at least essentially parallel,

29. Curtain coater as claimed in claim 4, wherein the outer rear face is totally planar.

30. Curtain coater as claimed in claim 7, wherein the thickness decreases constantly across the major part of the length of the curtain guide structure,

31. Curtain coater as claimed in claim 8, wherein the angle is 90°±30°.

32. Curtain coater as claimed in claim 10, wherein the biggest camber thickness is at least as thick as a slimmest remaining thickness of the curtain guide structure.
